(19) United States
(12) Patent Application Publication
(10) Pub. No.: US 2007/0000441 A1
(43) Pub. Date: Jan. 4, 2007

(54) Scalable uniform thermal plate

(75) Inventor: Brian C. Lue, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/402,564

(22) Filed: Apr. 12, 2006

Related U.S. Application Data
(60) Provisional application No. 60/696,392, filed on Jul. 1, 2005.

(51) Int. Cl. B05C 11/00

(52) U.S. Cl. 118/712

(57) ABSTRACT

Temperature of a processed workpiece may be regulated by flowing a thermal control fluid from a thermal source to a thermal drain, in a direction substantially normal to the plane occupied by the workpiece. This flow orientation ensures that any resulting temperature gradient in the thermal control fluid is also positioned substantially normal to the substrate, thereby avoiding processing variation in different areas of the workpiece attributable to an in-plane gradient. The thermal control fluid may be flowed from a common source to a plurality of pixel-like regions proximate to the workpiece, in order to ensure uniform temperature control. Use of such pixel-like regions promotes scalability of the temperature control apparatus.

### CROSS-REFERENCE TO RELATED APPLICATIONS

This instant nonprovisional application is related to commonly assigned U.S. patent application 60/696,392, filed on Jul. 1, 2005, the entire disclosure of which is incorporated herein by reference.

### BACKGROUND OF THE INVENTION

The present invention relates generally to the field of substrate processing equipment. More particularly, the present invention relates to a method and apparatus for controlling temperature of a semiconductor workpiece during processing.

Semiconductor device geometries have dramatically decreased in size since such devices were first introduced several decades ago. As device geometries have become more dense, reductions in the spacing between device elements has occurred. The minimum linewidths achieved using semiconductor lithography systems, sometimes referred to as a critical dimension (CD), have decreased over time.

Lithography or photolithography generally refers to processes for transferring patterns between a mask layer and a semiconductor substrate or workpiece. In lithography processes for semiconductor device fabrication, a silicon substrate is uniformly coated with a photosensitive material, referred to as a photoresist, in a cluster tool. A stepper/scanner tool selectively exposes the photoresist to some form of electromagnetic radiation to generate a circuit pattern corresponding to an individual layer of the integrated circuit (IC) device to be formed on the substrate surface. Generally, the photoresist film is selectively exposed using a mask layer that preferentially blocks a portion of the incident radiation. The portions of the photoresist film that are exposed to the incident radiation become more or less soluble depending on the type of photoresist that is utilized. A developing step dissolves the more soluble regions of the photoresist film, producing a patterned photoresist layer corresponding to the mask layer used in the exposure process. The precision with which the patterns are developed on the semiconductor substrate impacts the CDs present on the substrate, likely impacting device performance. Overdevelopment may result in an increase in linewidths, whereas underdevelopment may result in portions of the photoresist layer not being removed as desired.

During the resist processing described above, it may be necessary to heat and cool the semiconductor workpiece. Temperature nonuniformities can result in undesirable variation in resist processing, affecting consistency in structure and operation of active electrical devices fabricated on the same workpiece.

Therefore, there is a need in the art for improved systems and methods for controlling temperature of a semiconductor workpiece during processing.

### BRIEF SUMMARY OF THE INVENTION

Embodiments of methods and apparatuses in accordance with the present invention regulate temperature of a processed workpiece by flowing a thermal control fluid from a thermal source to a thermal drain, in a direction substantially normal to a plane occupied by a substrate. This flow orientation results in any temperature gradient in the thermal control fluid also being positioned normal to the plane of the workpiece, thereby reducing unwanted processing variation attributable to an in-plane temperature gradient. The thermal control fluid is flowed from a common source to a region proximate to the workpiece in a plurality of pixel like regions, in order to ensure uniform temperature control over various regions of the workpiece. The use of such pixel-like regions promotes scalability of the temperature control apparatus.

An embodiment of an apparatus in accordance with the present invention for processing a semiconductor workpiece, comprises, an upper surface configured to support a workpiece, and a plenum in thermal communication with the upper surface. The plenum comprises a first region in thermal communication with a source of a thermal control fluid and a drain of the thermal control fluid, such that a resulting thermal gradient in the thermal control fluid is oriented substantially normal to a plane defined by the upper surface.

An embodiment of a method in accordance with the present invention for controlling temperature of a workpiece, comprises, exchanging thermal energy between a workpiece and a thermal control fluid flowed in a direction substantially normal to a plane of the workpiece, such that a thermal gradient arising the thermal control fluid also lies in the direction substantially normal to the workpiece.

An alternative embodiment of a method in accordance with the present invention for controlling a temperature of a workpiece, comprises, forming a resist material on a workpiece, and exchanging thermal energy between a workpiece and a thermal control fluid flowed in a direction normal to a plane of the workpiece, such that a thermal gradient arising the thermal control fluid also lies in the direction normal to the workpiece.

These and other embodiments of the invention along with many of its advantages and features are described in more detail in conjunction with the text below and attached figures.

### BRIEF DESCRIPTION OF THE DRAWINGS

FIG. 1 is a plan view of one embodiment of a track lithography tool according to one embodiment of the present invention.

FIG. 2 is a simplified schematic diagram of a developer endpoint detection system according to a specific embodiment of the present invention.

FIG. 3A is a flowchart illustrating a processing sequence for a semiconductor substrate according to one embodiment of the present invention.

FIG. 3B is a flowchart illustrating a method of detecting developer endpoint according to one embodiment of the present invention.

FIG. 4 is a simplified schematic diagram of a developer endpoint detection system according to an alternative embodiment of the present invention.

FIG. 5 is a simplified cross-sectional view of an apparatus in accordance with an embodiment of the present invention.

FIGS. 6A-B are simplified schematic views showing the generation of an electrostatic chucking force between a wafer and an embodiment of the present invention.

FIG. 7 is a simplified timing diagram illustrating operation of an embodiment of an apparatus in accordance with the present invention.

FIG. 8 is a simplified perspective view of an apparatus in accordance with an embodiment of the present invention.

FIG. 9 is a simplified schematic diagram illustrating a conventional substrate support having the ability to control a temperature of a processed substrate.

FIG. 10 is a simplified schematic diagram illustrating an embodiment of a substrate support in accordance with the present invention having the ability to control a temperature of a processed substrate.

FIG. 11A is a simplified exploded view of one embodiment of a substrate support in accordance with the present invention.

FIG. 11B is an upper perspective view of a top cover of the embodiment of FIG. 11A.

FIG. 11C is a perspective view of the inverted top cover of the embodiment of FIG. 11A.

FIG. 11D is an upper perspective view of only the thermal plenum of the embodiment of FIG. 11A.

FIG. 11E is a cross-sectional view of the thermal plenum and bottom cover of the embodiment of FIG. 11A.

FIG. 11F is a lower perspective view of the thermal plenum of the embodiment of FIG. 11A, without the top cover.

FIG. 11G is a lower perspective view of the thermal plenum of the embodiment of FIG. 11A, with the top cover attached.

FIG. 11H shows a cross-sectional view of a portion of one embodiment of a support apparatus.

FIG. 11I illustrates temperature distribution within a water thermal control fluid, of the embodiment of FIG. 11H.

FIG. 11J illustrates temperature distribution within a water thermal control fluid and adjacent aluminum, of the embodiment of FIG. 11H.

FIG. 12A is a simplified perspective view illustrating an alternative embodiment of an upper plate of a thermal plenum in accordance with the present invention.

FIG. 12B is a simplified underside perspective view illustrating an alternative embodiment of a can in accordance with the present invention.

### DETAILED DESCRIPTION OF THE INVENTION

According to the present invention, techniques related to the field of semiconductor processing equipment are provided. One particular embodiment in accordance with the present invention relates to processing a semiconductor workpiece with resist material. Merely by way of example, the method and apparatus have been applied to processing a semiconductor workpiece with resist. It should be recognized that the invention has a much broader range of applicability.

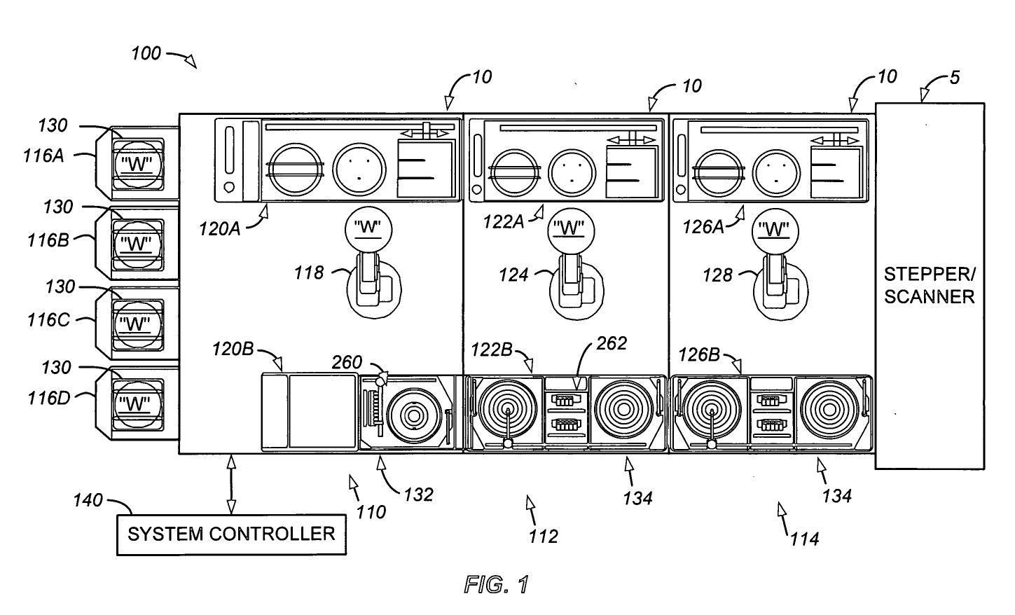

FIG. 1 is a plan view of an embodiment of a track lithography tool 100 in which the embodiments of the present invention may be used. As illustrated in FIG. 1, track lithography tool 100 contains a front end module 110 (sometimes referred to as a factory interface), a central module 112, and a rear module 114 (sometimes referred to as a scanner interface). Front end module 110 generally contains one or more pod assemblies or FOUPS (e.g., items 116A-D), a front end robot 118, and front end processing racks 120A and 120B. The one or more pod assemblies 116A-D are generally adapted to accept one or more cassettes 130 that may contain one or more substrates or wafer, “W,” that are to be processed in track lithography tool 100.

Central module 112 generally contains a first central processing rack 122A, a second central processing rack 122B, and a central robot 124. Rear module 114 generally contains first and second rear processing racks 126A and 126B and a back end robot 128. Front end robot 118 is adapted to access processing modules in front end processing racks 120A and 120B; central robot 124 is adapted to access processing modules in front end processing racks 120A, 120B, first central processing rack 122A, second central processing rack 122B, and/or rear processing racks 126A and 126B; and back end robot 128 is adapted to access processing modules in the rear processing racks 126A and 126B and in some cases exchange substrates with a stepper/scanner 5.

Stepper/scanner 5, which may be purchased from Canon USA, Inc. of San Jose, Calif., Nikon Precision Inc. of Belmont, Calif. or ASML US, Inc. of Tempe, Ariz., is a lithographic projection apparatus used, for example, in the manufacture of integrated circuits (ICs). Stepper/scanner 5 exposes a photosensitive material (resist), deposited on the substrate in the cluster tool, to some form of electromagnetic radiation to generate a circuit pattern corresponding to an individual layer of the integrated circuit (IC) device to be formed on the substrate surface.

Each of the processing racks 120A and 120B; 122A and 122B; and 126A and 126B contain multiple processing modules in a vertically stacked arrangement. That is, each of the processing racks may contain multiple stacked integrated thermal units 10, multiple stacked coater modules 132, multiple stacked coater/developer modules with shared dispense 262, or other modules that are adapted to perform the various processing steps required of a track lithography tool. As examples, coater modules 132 may deposit a bottom antireflective coating (BARC); coater/developer modules 134 may be used to deposit and/or develop photoresist layer sand integrated thermal units 10 may perform bake and chill operations associated with hardening BARC and/or photoresist layers.

In one embodiment, a system controller 140 is used to control all of the components and processes performed in the cluster tool 100. Controller 140 is generally adapted to communicate with stepper/scanner 5, monitor and control aspects of the processes performed in cluster tool 100, and is adapted to control all aspects of the complete substrate processing sequence. In some instances, controller 140 works in conjunction with other controllers, such as a post exposure bake (PEB) controller as described more fully below, to control certain aspects of the processing sequence. Controller 140, which is typically a microprocessor-based controller, is configured to receive inputs from a user and/or various sensors in one of the processing chambers and appropriately control the processing chamber components in accordance with the various inputs and software instructions retained in the controller's memory. Controller 140 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by controller 140 determines which tasks are performable in the processing chamber(s). Preferably, program is software readable by controller 140 and includes instructions to monitor and control the process based on defined rules and input data.

FIG. 1 further illustrates a coater/developer module with a shared dispense 262 mounted in second central processing rack 122B, that may adapted to perform a photoresist coat step or a develop step in both of the modules 110 and 112. This configuration is advantageous since it allows some of the common components found in the two modules 110 and 112 to be shared thus reducing the system cost, complexity and tool footprint.

It is to be understood that the embodiments of the invention are not limited to use with a track lithography tool such as that depicted in FIG. 1. Instead, embodiments of the invention may be used in any track lithography tool including the many different tools and configurations described in U.S. application Ser. No. 11/112,281, entitled “Cluster Tool Architecture for Processing a Substrate” filed on Apr. 22, 2005 (attorney docket number AM 009540), which is hereby incorporated by reference for all purposes and including configurations not described in the AM 009540 application.

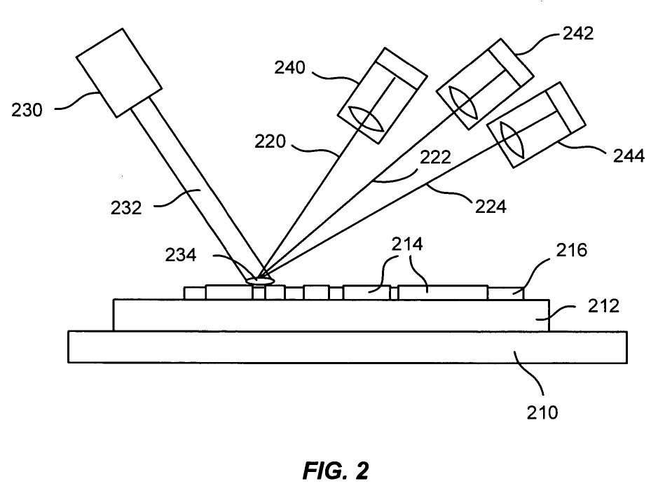

FIG. 2 is a simplified schematic diagram of a developer endpoint detection system according to a specific embodiment of the present invention. The developer endpoint detection systems provided by embodiments of the present invention are generally provided inside coater/developer modules 134 or inside the coater/developer module with a shared dispense 262. As described below, elements of developer endpoint detection systems according to the present invention are positioned inside the developer modules in locations above the plane of the substrate. Merely by way of example, in a specific embodiment, the optical elements are mounted in opposing upper corners of the process module or chamber. Of course, one of ordinary skill in the art would recognize many variations, modifications, and alternatives.

As will be evident to one of skill in the art, it is not necessary that every element of systems according to the present invention be located inside the developer module or chamber, as, for example, optical radiation produced by an external source may be communicated to the developer module, or other chamber in which the endpoint detection measurements are made, through fiber optic cables. Additionally, as discussed more fully below in relation to baseline measurements, developer endpoint detection systems provided by embodiments of the present invention may be contained in process chambers other than the coat/develop modules. Moreover, although in a particular embodiment, the methods and systems of the present invention are applied in the context of a lithographic development process, the present invention is not limited to this application. In alternative embodiments, other develop processes are included in the scope of the present invention.

As illustrated in FIG. 2, which provides a side view of one embodiment of the present invention, a support surface 210 is provided and a substrate 212 is mounted on the support surface. Although FIG. 1 does not illustrate substrates “W” as mounted in modules 134 or 262, one of skill in the art will appreciate that substrates are positioned in the coat/develop modules during various stages of processing. Typically, the substrate is a semiconductor wafer at one stage of processing. In some embodiments, the support surface is an electrostatic chuck coupled to a drive mechanism (not shown) that is adapted to translate the substrate 212 vertically and rotate the substrate as well. In alternative embodiments, the support surface 210 is a vacuum chuck. One of ordinary skill in the art would recognize many variations, modifications, and alternatives.

As illustrated in FIG. 2, substrate 212 is patterned to form a number of device features 214 distributed on a surface of the substrate. Generally the device features are associated with ICs fabricated on the substrate. As is well known to one of skill in the art, the process of manufacturing ICs may include more than 100 steps, with many of the steps being photolithography processes. Accordingly, although FIG. 2 simply illustrates a single group of device features 214 on the surface of the substrate, it is understood that the figure illustrates a stage of processing in which a number of layers may have already been patterned on the substrate. In addition, many additional layers may yet be patterned on the substrate surface. FIG. 2 is not drawn to scale, as generally, device features associated with ICs fabricated on the substrate are of micron and sub-micron dimensions and not clearly resolved without microscopic techniques.

Optical source 230 produces beam 232, which is directed toward the surface of the substrate 212. The beam is illustrated as collimated in FIG. 2 and an optical system (not shown) is used in some embodiments to provide a beam of the desired dimensions at the surface of the substrate. In one embodiment, the area on the surface of the substrate, on which the beam emitted from the laser 230 is projected, is defined as the detection area 234. In one embodiment, the size of the detection area is varied or controlled so that the amount of noise contained in the detected signal is minimized. Noise in the detected signal can be generated due to the variation in the pattern topology seen by the detection area during processing. Accordingly, in one embodiment, the beam is expanded and collimated to expose a number of different device features. In other embodiments, the beam is focused to a reduced diameter and then collimated to expose a fewer number of device features using the beam 232. Of course, the particular beam dimensions selected will depend on the various applications.

Generally, the optical source 230 is a tunable, single-wavelength laser, but this is not required by the present invention. In alternative embodiments, the optical source is a discharge lamp or other narrow band optical source selected for the output wavelength and spectral bandwidth. In alternative embodiments, the optical source 230 is a group of single frequency laser sources optically combined to produce a single, multi-spectral beam. One of ordinary skill in the art would recognize many variations, modifications, and alternatives. As described more fully below, a multi-spectral beam, either generated sequentially using a tunable source or simultaneously using one or more lasers, for example, enables enhanced system performance.

As illustrated in FIG. 2, a developer puddle 216 is illustrated on the surface of the substrate and intermingled with the device features 214. Although the developer puddle 216 illustrated in FIG. 2 is at a level below the upper surfaces of the device features, this is not required by the present invention. As will be evident to one of skill in the art, embodiments of the present invention may be used with developer puddles thicker than the device features being developed. Optical beam 232 impinges on the surface of the device features and the developer puddle and is reflected off the interfaces defining the boundaries of the device features and the developer puddle.

Additionally, the beam is refracted as it enters the developer puddle, subsequently reflecting off device features submerged under the developer puddle and refracting at the developer puddle/air interface. Moreover, the beam is diffracted by features on the order of the wavelength of the optical beam. For many sub-micron device features, significant diffraction of the beam results. In FIG. 2, these complex optical processes are represented by beams 220, 222, and 224. One of ordinary skill in the art would recognize that scattering of the beam as a result of diffuse reflection off the surface will generally result in a cone of scattered radiation, depending on the proportions of specular and diffuse reflection. Additionally, multiple reflections off layers and interfaces will generate interference patterns and other optical phenomena. For purposes of clarity in the illustration, these effects are incorporated into the simple beam 220, although it is appreciated that an optical system (not shown) is generally utilized to collect, collimate, and/or image the radiation reflected from the substrate surface onto the detectors 240, 242, and 244.

In one embodiment, the detector 240 is oriented to receive a primary reflection from the surface and thus is aligned with the incident beam (e.g., the same absolute value for the angle of incidence relative to the surface as the beam 232). Due to the interference between the impinging beam and the pattern formed in the resist during the exposure and develop processes, the intensity of the detected radiation at detector 240 will vary as the development step progresses. In one embodiment, the variation in the intensity of the reflected radiation detected by detector 240 is created when the developer dissolves the soluble portions of the photoresist during the development process, thus causing a pattern to emerge as from a “grating” type feature, thereby generating interference with the impinging beam. Therefore, the interference with the photoresist pattern causes scattering of the impinging beam, which causes a reduction in the main reflection that is detected at detector 240. In one embodiment, the developer endpoint is detected when the change in the reflected intensity measured by the detector 240 asymptotically approaches zero.

Although in some embodiments, the device features form a “grating” type diffraction pattern as a result of beam 232 striking the substrate surface, this is not to say a “diffraction grating,” defined as a repetitive array of diffracting elements, either apertures or obstacles, that has the effect of producing periodic alterations in the phase, amplitude, or both of an emergent wave, is required by embodiments of the present invention. In some embodiments, a photolithographically defined diffraction grating feature may be provided on the surface of the substrate, in a more general sense, the actual structure of the various device features (e.g., submicron features) produces diffraction of light. Therefore, embodiments of the present invention include both traditional diffraction gratings as well as diffraction effects resulting from actual device features.

In one embodiment, a tunable laser is used in place of a single wavelength laser to more easily detect the change in the sharpness of the resist pattern as the develop process progresses. The amount of interference will depend on the size of the formed “grating” and the wavelength of the incident radiation. In another embodiment, a number of detectors (e.g., 240, 242, and 244) are utilized that detect the zero-order reflection as well as higher diffracted orders. As illustrated in FIG. 2, detector 242 detects the first-order diffracted beam at wavelength λ₁ and detector 244 detects the first-order diffracted beam at wavelength λ₂. Although two detectors 242 and 244 are illustrated for detecting the first-order diffracted beam, in alternative embodiments, a one or two-dimensional detector array, for example, a two-dimensional charge coupled device (CCD) array, is utilized to detect the first-order beam. The endpoint detection process includes monitoring the scattering/diffraction and shift in intensity of the reflected radiation for the various diffracted orders. One of ordinary skill in the art would recognize many variations, modifications, and alternatives. To prevent noise generated from the reflection of emitted radiation from the developer puddle present on the substrate surface during the development process, a slit may be used to prevent the specular reflection from this layer from reaching the detectors.

In the above discussion, a primary diffracted order associated with multiple wavelengths was detected using multiple detectors. As one of skill in the art will appreciate from examination of the grating equation, a pattern with multiple periodicities will produce diffracted beams oriented at multiple angles even for a monochromatic source. Therefore, in some embodiments of the present invention, detectors 242 and 244 are used to detect beams diffracted at two angles from the surface of the substrate. Of course two-dimensional CCD arrays may also be utilized. One of skill in the art will understand that in general, the diffraction pattern produced in the plane of the detectors will be a function of the incident radiation spectral content, as well as the periodicities present in the patterned surface. Thus, in some embodiments, analysis functions incorporating these complexities will be provided.

In some embodiments, the substrate is spinning during the development process. Thus, in a specific embodiment of the present invention, light reflected and diffracted from the detection area is time averaged as the substrate rotates with respect to the optical beam. In this specific embodiment, a “bulk” or average measurement is made that corresponds to the portions of the substrate and device features sweeping past the optical beam as a function of time.

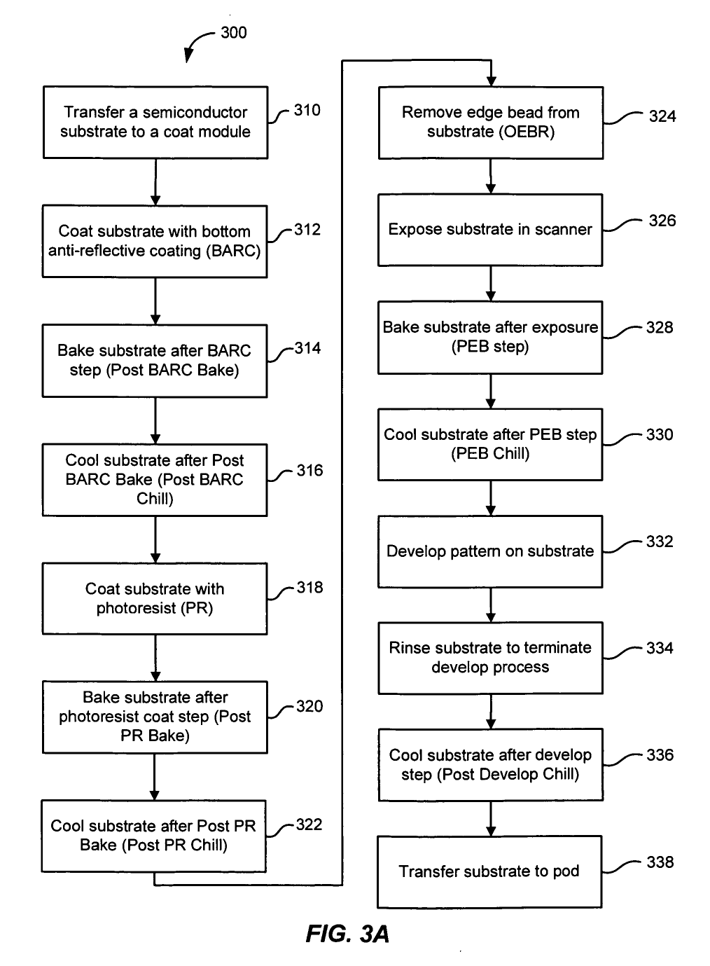

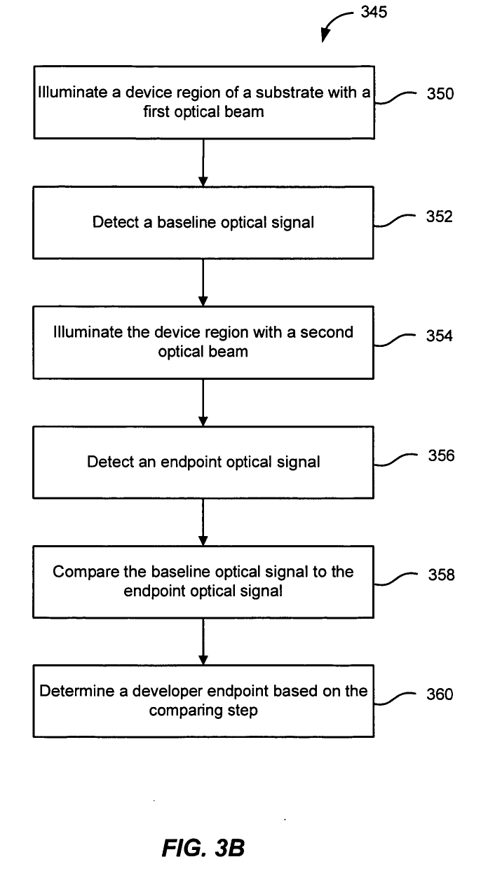

FIG. 3A is a flowchart illustrating a processing sequence for a semiconductor substrate according to one embodiment of the present invention. FIG. 2 illustrates one embodiment of a series of method steps 300 that may be used to deposit, expose and develop a photoresist material layer formed on a substrate surface. The lithographic process may generally contain the following: a transfer substrate to coat module step 310, a bottom anti-reflective coating (BARC) coat step 312, a post BARC bake step 314, a post BARC chill step 316, a photoresist coat step 318, a post photoresist bake step 320, a post photoresist chill step 322, an optical edge bead removal (OEBR) step 324, an exposure step 326, a post exposure bake (PEB) step 328, a post exposure bake chill step 330, a develop step 332, a rinse step 334, a cool step 336, and a transfer substrate to pod step 338. In other embodiments, the sequence of the method steps 300 may be rearranged, altered, one or more steps may be removed, or two or more steps may be combined into a single step with out varying from the basic scope of the invention.

In step 310, a semiconductor substrate is transferred to a coat module. Referring to FIG. 1, the step of transferring the substrate to the coat module 310 is generally defined as the process of having the front end robot 118 remove a substrate from a cassette 130 resting in one of the pod assemblies 116. A cassette 130, containing one or more substrates “W”, is placed on the pod assembly 116 by the user or some external device (not shown) so that the substrates can be processed in the cluster tool 100 by a user-defined substrate processing sequence controlled by software retained in the system controller 140.

The BARC coat step 312 is a step used to deposit an organic material over a surface of the substrate. The BARC layer is typically an organic coating that is applied onto the substrate prior to the photoresist layer to absorb light that otherwise would be reflected from the surface of the substrate back into the resist during the exposure step 326 performed in the stepper/scanner 5. If these reflections are not prevented, standing waves will be established in the resist layer, which cause feature size to vary from one location to another depending on the local thickness of the resist layer. The BARC layer may also be used to level (or planarize) the substrate surface topography, which is generally present after completing multiple electronic device fabrication steps. The BARC material fills around and over the features to create a flatter surface for photoresist application and reduces local variations in resist thickness. The BARC coat step 312 is typically performed using a conventional spin-on resist dispense process in which an amount of the BARC material is deposited on the surface of the substrate while the substrate is being rotated which causes a solvent in the BARC material to evaporate and thus causes the material properties of the deposited BARC material to change. The air flow and exhaust flow rate in the BARC processing chamber is often controlled to control the solvent vaporization process and the properties of the layer formed on the substrate surface.

The post BARC bake step 314, is a step used to assure that all of the solvent is removed from the deposited BARC layer in the BARC coat step 312, and in some cases to promote adhesion of the BARC layer to the surface of the substrate. The temperature of the post BARC bake step 314 is dependent on the type of BARC material deposited on the surface of the substrate, but will generally be less than about 250° C. The time required to complete the post BARC bake step 314 will depend on the temperature of the substrate during the post BARC bake step, but will generally be less than about 60 seconds.

The post BARC chill step 316, is a step used to control and assure that the time the substrate is above ambient temperature is consistent so that every substrate sees the same time-temperature profile and thus process variability is minimized. Variations in the BARC process time-temperature profile, which is a component of a substrates wafer history, can have an effect on the properties of the deposited film layer and thus is often controlled to minimize process variability. The post BARC chill step 316, is typically used to cool the substrate after the post BARC bake step 314 to a temperature at or near ambient temperature. The time required to complete the post BARC chill step 316 will depend on the temperature of the substrate exiting the post BARC bake step, but will generally be less than about 30 seconds.

The photoresist coat step 318, is a step used to deposit a photoresist layer over a surface of the substrate. The photoresist layer deposited during the photoresist coat step 318 is typically a light sensitive organic coating that are applied onto the substrate and is later exposed in the stepper/scanner 5 to form the patterned features on the surface of the substrate. The photoresist coat step 318 is a typically performed using conventional spin-on resist dispense process in which an amount of the photoresist material is deposited on the surface of the substrate while the substrate is being rotated which causes a solvent in the photoresist material to evaporate and thus causes the material properties of the deposited photoresist layer to change. The air flow and exhaust flow rate in the photoresist processing chamber is controlled to control the solvent vaporization process and the properties of the layer formed on the substrate surface. In some cases it may be necessary to control the partial pressure of the solvent over the substrate surface to control the vaporization of the solvent from the resist during the photoresist coat step by controlling the exhaust flow rate and/or by injecting a solvent near the substrate surface. Referring to FIG. 1, in an exemplary photoresist coating process, the substrate is first positioned on coater/developer module 134. A motor rotates the substrate while the photoresist is dispensed onto the center of the substrate. The rotation imparts an angular torque onto the photoresist, which forces the photoresist out in a radial direction, to ultimately cover the substrate.

The post photoresist bake step 320, is a step used to assure that all of the solvent is removed from the deposited photoresist layer in the photoresist coat step 318, and in some cases to promote adhesion of the photoresist layer to the BARC layer. The temperature of the post photoresist bake step 320 is dependent on the type of photoresist material deposited on the surface of the substrate, but will generally be less than about 250° C. The time required to complete the post photoresist bake step 320 will depend on the temperature of the substrate during the post photoresist bake step, but will generally be less than about 60 seconds.

The post photoresist chill step 322, is a step used to control the time the substrate is at a temperature above ambient temperature so that every substrate sees the same time-temperature profile and thus process variability is minimized. Variations in the time-temperature profile can have an effect on properties of the deposited film layer and thus is often controlled to minimize process variability. The temperature of the post photoresist chill step 322, is thus used to cool the substrate after the post photoresist bake step 320 to a temperature at or near ambient temperature. The time required to complete the post photoresist chill step 322 will depend on the temperature of the substrate exiting the post photoresist bake step, but will generally be less than about 30 seconds.

The optical edge bead removal (OEBR) step 324, is a process used to expose the deposited light sensitive photoresist layer(s), such as, the layers formed during the photoresist coat step 318 and the BARC layer formed during the BARC coat step 312, to a radiation source (not shown) so that either or both layers can be removed from the edge of the substrate and the edge exclusion of the deposited layers can be more uniformly controlled. The wavelength and intensity of the radiation used to expose the surface of the substrate will depend on the type of BARC and photoresist layers deposited on the surface of the substrate. An OEBR tool can be purchased, for example, from USHIO America, Inc. Cypress, Calif.

The exposure step 326, is a lithographic projection step applied by a lithographic projection apparatus (e.g., stepper/scanner 5) to form a pattern which is used to manufacture integrated circuits (ICs). The exposure step 326 forms a circuit pattern corresponding to an individual layer of the integrated circuit (IC) device on the substrate surface, by exposing the photosensitive materials, such as, the photoresist layer formed during the photoresist coat step 318 and the BARC layer formed during the BARC coat step 312 of some form of electromagnetic radiation.

The post exposure bake (PEB) step 328, is a step used to heat a substrate immediately after the exposure step 326 in order to stimulate diffusion of the photoactive compound(s) and reduce the effects of standing waves in the resist layer. For a chemically amplified resist, the PEB step also causes a catalyzed chemical reaction that changes the solubility of the resist. The control of the temperature during the PEB is typically critical to critical dimension (CD) control. The temperature of the PEB step 328 is dependent on the type of photoresist material deposited on the surface of the substrate, but will generally be less than about 250° C. The time required to complete the PEB step 328 will depend on the temperature of the substrate during the PEB step, but will generally be less than about 60 seconds.

The post exposure bake (PEB) chill step 330, is a step used to control the assure that the time the substrate is at a temperature above ambient temperature is controlled so that every substrate sees the same time-temperature profile and thus process variability is minimized. Variations in the PEB process time-temperature profile can have an effect on properties of the deposited film layer and thus is often controlled to minimize process variability. The temperature of the PEB chill step 330, is thus used to cool the substrate after the PEB step 328 to a temperature at or near ambient temperature. The time required to complete the PEB chill step 330 will depend on the temperature of the substrate exiting the PEB step, but will generally be less than about 30 seconds.

The develop step 332, is a process in which a solvent is used to cause a chemical or physical change to the exposed or unexposed photoresist and BARC layers to expose the pattern formed during the exposure process step 326. The develop process may be a spray or immersion or puddle type process that is used to dispense the developer solvent. In some develop processes, the substrate is coated with a fluid layer, typically deionized water, prior to application of the developer solution and spun during the development process. Subsequent application of the developer solution results in uniform coating of the developer on the substrate surface. In step 334, a rinse solution is provided to surface of the substrate, terminating the develop process. Merely by way of example, the rinse solution may be deionized water. In alternative embodiments, a rinse solution of deionized water combined with a surfactant is provided. One of ordinary skill in the art would recognize many variations, modifications, and alternatives.

In step 336, the substrate is cooled after the develop and rinse steps 332 and 334. In step 338, the substrate is transferred to the pod, thus completing the processing sequence. Transferring the substrate to the pod in step 338 generally entails the process of having the front end robot 118 return the substrate to a cassette 130 resting in one of the pod assemblies 116.

In the discussion of the previous processing sequence, transfer of the substrate from various chambers of the track lithography tool 100 to other chambers was generally omitted for purposes of clarity. One of skill in the art will appreciate the use of a number of transfer robots to accomplish the various transfers between appropriate chambers.

As discussed below, in accordance with embodiments of the present invention, after step 334 or 336, a solution is applied to the wafer containing a mixture of different marker molecules. The mix may, for example, include molecules targeting the optimum CD and the upper and lower control limits. Molecules of each type would have different color fluorescent tags. In another embodiment, the wafer used to rinse the substrate to terminate development (step 334) contains marker molecules.

FIG. 3B is a flowchart illustrating a method 345 of detecting developer endpoint according to one embodiment of the present invention. In step 350, a device region of a substrate is illuminated with a first optical beam. In some embodiments of the present invention, step 350 occurs prior to a current development stage of processing. Thus, for some product substrates, a pattern will be present on the device surface from previous processing steps. For substrates with previously developed patterns, step 350 occurs before development of a newly exposed pattern begins. In step 352, a baseline optical signal is detected by collecting radiation scattered from the surface of the substrate. As discussed previously, submicron patterns associated with the IC features and present on the device surface will reflect and diffract light. Additionally, refraction of light at the interfaces between fluids present on the surface and the device features will occur, generating a reflectometry and/or scatterometry profile.

In embodiments of the present invention, the baseline optical signal detected in step 352 is collected at any one of several stages of the processing sequence 300 illustrated in FIG. 3A. In some of these embodiments, the baseline optical signal is detected at stages of processing prior to the initiation of the development process in step 332 for the particular layer being developed. Moreover, in some embodiments, the baseline optical signal is detected in one of several process chambers. For example, methods and apparatus according to embodiments of the present invention may be provided in a coat chamber, a bake chamber, and the like. Merely by way of example, the baseline optical signal may be collected:

Pre-Resist—Prior to the coating of the substrate with photoresist in step 318. The underlying pattern resulting from previous processing steps will determine the baseline signal. In embodiments utilizing collection of the baseline optical signal prior to the PR coat step 318, the substrate may be transferred to a develop module in which a developer endpoint detection system according to an embodiment of the present invention is present. Alternatively, other embodiments of the present invention will provide either a portion of a developer endpoint detection system or a complete developer endpoint detection system in the coat module in which the PR coat process is performed. Accordingly, the baseline optical signal is collected prior to the PR coat process 318.

Post-Exposure—After exposure of the photoresist pattern in the scanner in step 326. Experiments have demonstrated that a latent image is present after exposure, thereby generating a baseline signal differing from the signal collected after the photoresist coating step. An explanation for the presence of the latent image is the presence of the underlying layers produced in previous processing steps. Another explanation for the latent image is the interaction between the exposure photons and the photoresist, resulting in compositional differences in the photoresist as a function of exposure dose. Although these theories provides support for describing the embodiments of the present invention, the present invention is not limited to these explanations are limited by them. Accordingly, in some embodiments, the baseline optical signal is collected after exposure in step 326 by transferring the substrate to a module including either a portion of a developer endpoint detection system or a complete developer endpoint detection system according to an embodiment of the present invention.

After Post-Exposure Bake—After the exposed substrate is baked in step 328 to activate chemical enhancement of the exposed photoresist layer. Experiments have demonstrated that a latent image is present after the post-exposure bake (PEB) step, thereby generating a baseline signal differing from the signal collected after the photoresist coating step. As discussed in relation to measurements made after the exposure step, the interaction of exposure photons with the optically activated photoresist is enhanced by the PEB step. Compositional differences in the exposed vs. unexposed photoresist are amplified by the bake step, resulting in additional contrast for the latent image.

After Substrate Coating—In some development processes, the substrate is coated with a fluid layer, typically deionized water, prior to application of the developer solution.

In embodiments in which the baseline signal is collected after substrate coating, the measurement is made in the developer module so that the substrate does not have to be moved between the baseline measurement and the endpoint measurement.

In step 354, the device region of the substrate is illuminated with a second optical beam. In some embodiments, the first optical beam and the second optical beam are produced by the same laser. In this case, the first and second optical beams will typically be collinear and will be sequentially projected onto the same detection area. In embodiments in which the baseline optical signal is measured after substrate coating, the substrate will generally be positioned in the same location during both the baseline measurement and the endpoint measurement. In embodiments in which the baseline measurement is made at prior stages of the exposure and development process, methods and systems are provided to orient the substrate prior to illumination, thereby enabling the system operator to produce repeatable results.

In step 356, an endpoint optical signal is detected from the device region of the substrate. As described in relation to FIG. 2, one or more detectors may be used in various embodiments of the present invention to detect one or more diffracted orders reflected, diffracted, and scattered off the substrate surface.

In some embodiments, the first and second optical beams will be multi-spectral beams containing a number of distinct wavelength components. In other embodiments, a tunable laser is used to generate a beam that produces a variety of different wavelengths as a function of time. In the case of a tunable laser, multiple baseline optical signal and multiple endpoint optical signals may be collected as a function of time using the various detectors illustrated in FIG. 2. One of ordinary skill in the art would recognize many variations, modifications, and alternatives resulting from the combination of a tunable source, diffraction effects as a function of wavelength and 2-D CCD arrays.

In step 358, the baseline optical signal and the endpoint optical signal are compared using algorithms adapted to this comparison task. Based on the comparison step, a developer endpoint is determined in step 360. In one embodiment, the intensity, for example, of the beam 220 at detector 240 is measured during the develop process and compared to the base line measurement made using detector 240. As the develop process progresses, changes in the endpoint signal will occur. In some embodiments, the endpoint signal will change during the development process and stabilize as the developer endpoint is reached. In some embodiments, the analysis of the detected signal includes examination of the spectral content received at the detectors, while in alternative embodiments, a single wavelength is used to determine the developer endpoint.

As developer endpoint is detected, a control system (not shown) provides feedback to the develop chamber, activating the release of a rinse solution onto the substrate surface. In a specific embodiment, a rinse solution of deionized water is provided to the substrate, terminating the develop process. In alternative embodiments, a rinse solution of deionized water combined with a surfactant is provided. One of ordinary skill in the art would recognize many variations, modifications, and alternatives.

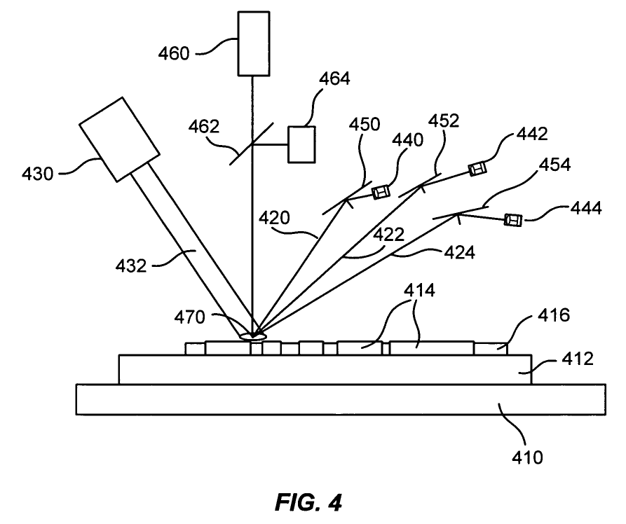

FIG. 4 is a simplified schematic diagram of a developer endpoint detection system according to an alternative embodiment of the present invention. FIG. 4 shares some similarities with FIG. 2 and for purposes of brevity, the description provided with reference to FIG. 2 will suffice to describe elements of FIG. 4. In FIG. 4, optical source 430, which may be a single frequency or tunable laser, produces optical beam 432, which is directed toward the surface of the substrate 412. The substrate is supported on chuck 410.

As illustrated in FIG. 4, a developer puddle 416 is illustrated on the surface of the substrate and intermingled with the device features 414. Although the developer puddle 416 illustrated in FIG. 4 is at a level below the upper surfaces of the device features, this is not required by the present invention. As will be evident to one of skill in the art, embodiments of the present invention may be used with developer puddles thicker than the device features being developed. Optical beam 432 impinges on the surface of the device features and the developer puddle and is reflected off the interfaces defining the boundaries of the device features and the developer puddle.

Additionally, the beam is refracted as it enters the developer puddle, subsequently reflecting off device features submerged under the developer puddle and refracting at the developer puddle/air interface. Moreover, the beam is diffracted by features on the order of the wavelength of the optical beam. For many sub-micron device features, significant diffraction of the beam results. In FIG. 4, these complex optical processes are represented by beams 420, 422, and 424. One of ordinary skill in the art would recognize that scattering of the beam as a result of diffuse reflection off the surface will generally result in a cone of scattered radiation, depending on the proportions of specular and diffuse reflection. Additionally, multiple reflections off layers and interfaces will generate interference patterns and other optical phenomena. For purposes of clarity in the illustration, these effects are incorporated into the simple beam 420, although it is appreciated that an optical system (not shown) is generally utilized to collect, collimate, and/or image the radiation reflected from the substrate surface onto the detectors 440, 442, and 444.

FIG. 4 also illustrates a second laser 460, beamsplitters 462, and detector 464. In some embodiments, the second laser 460 generates a beam that propagates along a line normal to the surface of the substrate 412, impinging on the detection area 470. As described below, the second laser, beamsplitters, and detector 464 are utilized to actively control for variation in the developer fluid surface. In some embodiments, external vibrations and other effects introduce perturbations in the surface of the developer fluid, locally modifying the surface of the developer from the desired planar surface parallel to the surface of the substrate. Using the system illustrated in FIG. 4, variations in the surface of the developer fluid will cause the beam reflected along path 466 to depart from a line collinear with the incident laser beam from laser 460. For example, if the developer surface tilts to the right, the reflected beam will veer to the right of the line normal to the developer surface, producing a detected spot above the line drawn between the beamsplitter 462 and the detector 464. Measurement of this beam deflection will be used to drive active mirrors, as described below.

Active mirrors 450, 452, and 454 are provided in the system illustrated in FIG. 4 and serve to correct for local modifications of the developer fluid surface. As variations in the developer surface are measured in the form of beam deflections at detector 464, a control system (not shown) provides inputs to actuate active mirrors 450, 452, and 454, thereby counteracting tilting of beams 420, 422, and 424 as a result of the location modifications of the developer surface.

In a specific embodiment, the detector 464 is a two-dimensional CCD array that monitors beam deflections in directions lying in the plane of the substrate. The active mirrors can be small and compact, such as those used on the micromirror chip available from Texas Instruments, Inc., of Dallas, Tex. For purposes of clarity, the active mirrors are shown an widely separated in FIG. 4, but one of skill in the art will appreciate that an array of mirrors, coupled to an array of detectors may be used according to embodiments of the present invention.

In alternative embodiments, a Fresnel lens (not shown) is utilized in the optical path between the substrate surface and the detectors 440, 442, and 444. In some embodiments, the Fresnel lens is selected because generally, Fresnel lenses are fast (low ratio of focal length to diameter) and thin in comparison to spherical lenses of the same diameter. The use of a lens in this optical path may provide for focusing of light onto the detectors, increasing the optical throughput of the system and enhancing system performance.

Chuck for Semiconductor Workpiece

As described above, the track tool may include a bake module 10. This bake module may be employed to perform one or more steps of heating the semiconductor workpiece being processed. For example, the bake module may be used in the “Post BARC Bake”, the “Post PR Bake”, or the post-exposure bake (PEB) steps.

In order to prevent the occurrence of significant temperature nonuniform ities on the wafer or workpiece during temperature transients resulting from baking and post-bake cooling, the thickness of the thermal gas gap separating the wafer from the underlying heater, should be maintained extremely uniform.

Accordingly, embodiments of the present invention employ a chuck featuring integrated resistive heating and electrostatic chucking elements positioned on a thermal pedestal. These integrated heating and chucking elements maintain wafer flatness, as well as uniformity of an underlying gap accommodating a thermal gas between the workpiece and the chuck. In accordance with one embodiment of the present invention, a wafer heater laminated with KAPTON™ is attached to the top of the thermal surface, under the wafer: At least two electrical voltage zones are isolated within the heater, in order to create a chucking force between the heater element and wafer without contacting the wafer with an electrical conductor. These voltage zones can be created by using separate conducting elements as well as by imposing a DC bias on zones including the resistive heating elements.

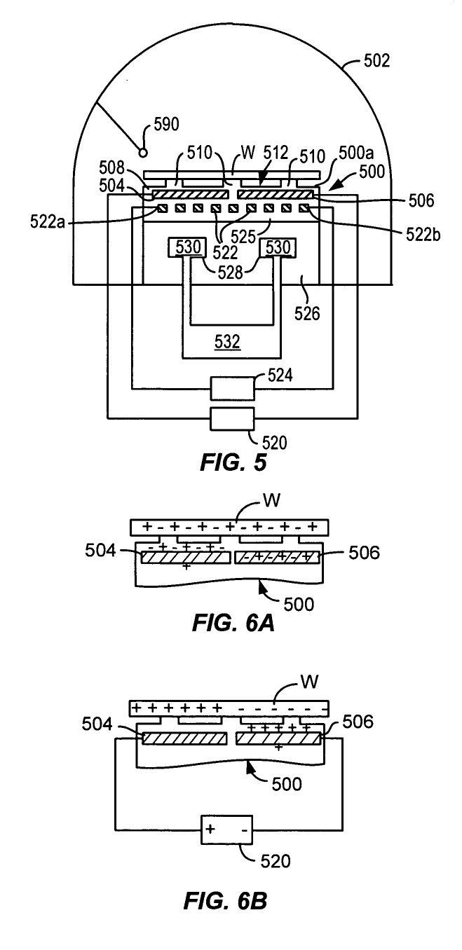

FIG. 5 is a simplified cross-sectional view of an embodiment of an apparatus in accordance with the present invention. Specifically, electrostatic chuck 500 is utilized to secure a workpiece W for processing within chamber 502. Electrostatic chuck 500 comprises electrodes 504 and 506 covered by an insulator or dielectric layer 508. In accordance with one specific embodiment of the present invention, electrodes 504 and 506 may comprise copper metal, and dielectric layer 508 may comprise KAPTON™.

As shown in FIG. 5, the upper surface scan of chuck 500 further includes raised stand-off features 510 configured to maintain workpiece W over chuck 500 separated by a thermal gas gap 512. Typically, thermal gas gap 512 has a width of about 100 μm or less, sufficient to allow circulation of thermal gases under the wafer to uniformly transfer thermal energy to and from underlying chuck. In accordance with one embodiment of the present invention, it has been found that about seventeen (17) stand-off supports are optimally used to support the workpiece over the surface of the chuck, as determined by finite element analysis.

When electrodes 504 and 506 of the chuck 500 are electrically biased with respect to one another, an attractive electrostatic force is generated that binds the workpiece to the chuck. Specifically, FIGS. 6A-B present greatly simplified schematic views illustrating the attractive force generated by application of a potential difference between the bipolar electrodes of the workpiece support. FIG. 6A shows workpiece W resting on chuck 500, with no potential difference applied between electrodes 504 and 506. Charge is evenly distributed on workpiece W, and no electrostatic attractive force is present between workpiece W and underlying chuck 500.

FIG. 6B shows the subsequent application of a potential difference between electrodes 504 and 506 from power source 520. As a result of the application of this potential difference, electrodes 504 and 506 become oppositely charged. Moreover, charge present in workpiece W is redistributed under the influence of charged electrodes 504 and 506. Specifically, charge of the opposite type is attracted to regions of the workpiece proximate to the respective electrodes. These charge differences in turn give rise to an electrostatic attraction between workpiece W and chuck 500. In accordance with one embodiment of the present invention, it has been found that application of a potential difference of between about 800-1200 V to a pair of copper electrodes provides sufficient electrostatic attractive force to secure a workpiece having a diameter of 300 mm to the chuck, maintaining a thermal gas gap a uniform precise distance of 100 μm.

With reference to FIG. 6B, it is important to note that workpiece W as a whole remains electrically neutral during the electrostatic chucking process. Therefore, there is no need to place the workpiece into contact with an electrical conductor in order to maintain charge neutrality during chucking.

Returning to FIG. 5, electrostatic chuck 500 also comprises resistive heating element 522 underlying electrodes 504 and 506. Heating element 522 is formed from an electrically conducting material, and are configured to generate heat in response to the passage of current. Such current is induced by placing terminals 522a and 522b of resistive heating element in electrical communication with source 524 of a potential difference. In accordance with one embodiment of the present invention, heating element 522 may be comprised of a high resistance material such as INCONEL™.

Electrostatic heating elements are embedded within, and separated from the overlying electrodes by, dielectric material 508. In accordance with one embodiment of the present invention, the electrodes and the resistive heating elements may be electrically isolated from one another, and feature separate terminals for operating under the influence of different (or the same) potential differences. Such an embodiment offers the advantage of greater flexibility, with electrostatic chucking functionality entirely decoupled from heating.

Cooling of semiconductor workpiece W is accomplished by supporting chuck 500 on the surface of thermal pedestal 526 defining an internal channels 528. Channels 528 are in fluid communication with heat transfer circulator 532, and are configured to circulate a heat control fluid 530 such as air, water, or helium through pedestal 526. Fluid 530 absorbs heat from pedestal 526, and its circulation then allows for replacement with cooler fluid.

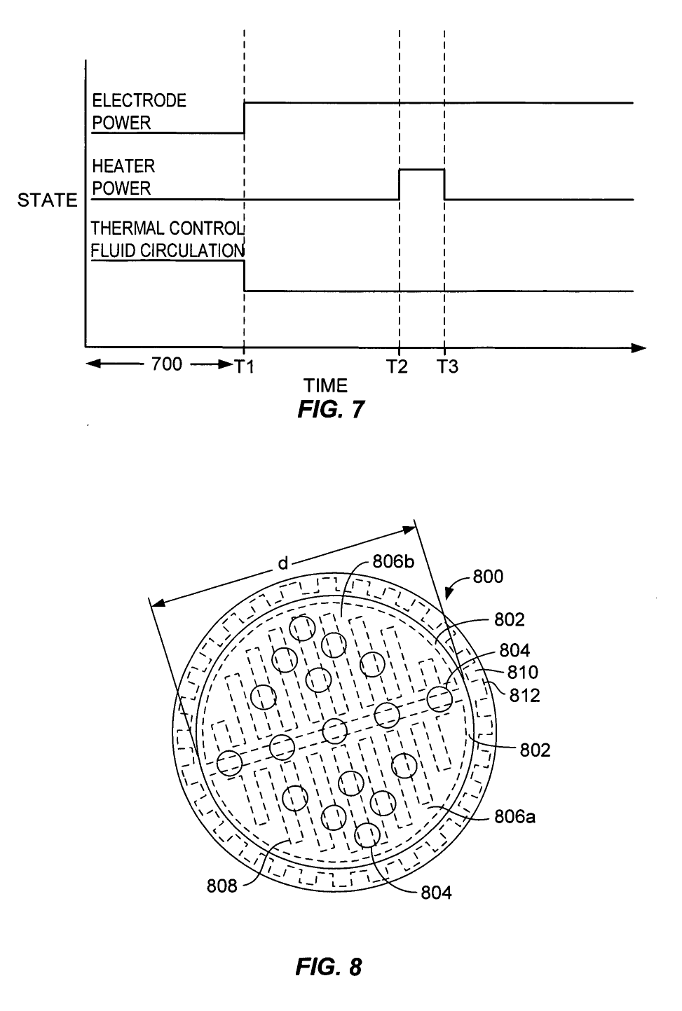

Operation of chuck 500 is now described below in connection with the simplified timing diagram of FIG. 7. During a first period 700 prior to introduction of the workpiece into chamber, heat control fluid is actively circulated through the channels of the thermal pedestal. No current is flowed through resistive heater element at this time. As a result, the pedestal and chuck are maintained at a constant temperature.

At time T1, a robot arm (not shown) transports the workpiece into the chamber. A lift finger assembly has lift fingers that are elevated through the chuck by a pneumatic lift mechanism. The robot arm places the substrate on the tips of the lift fingers, and the pneumatic lift mechanism, under the control of a computer system, lowers the workpiece onto the chuck. At this point the workpiece is in contact with raised set-off features, and is separated chuck surface by the thermal gas gap.

Once the workpiece has been placed on the chuck, the electrodes of the chuck are electrically biased with respect to one another by a chuck voltage supply to electrostatically secure the workpiece. Also at time T1, circulation of the thermal control fluid through the pedestal is halted. In this manner, the chucked wafer and the chuck are at substantially the same temperature.

Once the wafer has been secured onto the chuck at time T1, at a subsequent time T2, current is flowed through the heating element to cause resistive heating. As shown in FIG. 5, the chamber includes a temperature sensor 590 positioned above the surface of the chuck to monitor temperature. Several designs of temperature sensors may be employed. One temperature sensor design is described in detail in published U.S. patent application no. 2003/0209773, coassigned with the instant application and incorporated herein by reference for all purposes.

Power is applied to the resistive heating elements until a target temperature is reached. At time T3, the supply of power to the heating elements is ceased, as is the supply of power to the chucking elements. The processed workpiece may then be removed from the chuck and from the chamber.

FIG. 7 presents a greatly simplified view of the sequence of events of one embodiment of an application of the present invention, and variations will be recognized. For example, the temperature of the wafer and the chuck may be maintained at a target temperature for a period of time prior to removal of the wafer from the chamber. Such temperature regulation can occur, for example, through a feedback mechanism utilizing the heating elements to apply thermal energy, and circulation of fluid through the channels of the thermal pedestal to remove thermal energy. In accordance with still another approach, the processed workpiece could be allowed to cool on the chuck for a period prior to removal from the chamber.

FIG. 8 presents a detailed perspective view of an embodiment of a chuck apparatus in accordance with the present invention. Chuck 800 includes upper dielectric surface 802 having a diameter ‘d’ slightly greater than that of the expected workpiece. Upper dielectric surface 802 bears a plurality of raised stand-off features 804, typically having a height of 100 μm or less. Bipolar electrode pair 806a and 806b underlie dielectric surface 802. Resistive heating element 808 in turn underlies bipolar electrode pair 806a and 806b.

Chuck 800 further includes a peripheral portion 810 including a secondary heating element 812. Secondary heating element 812 can be separately controllable to counteract thermal effects occurring at the edge of the wafer, in order to ensure temperature uniformity across the entire diameter of the wafer.

Thermal Control Unit for Processing Semiconductor Workpiece

The substrate support for the bake module of the track tool is not limited to the specific example described above. In accordance with alternative embodiments, the wafer support apparatus may comprise a plurality of fluid channels arranged in a pixel-like configuration, with each pixel comprising a thermal control fluid inlet and a thermal control fluid outlet. Thermal control fluid is introduced and removed from a pixel in a direction normal to the plane of the substrate. This limited exposure of the thermal control fluid to energy from the substrate, allows for more precise temperature control over the substrate, thereby limiting prolonged heating or cooling of the fluid that can complicate thermal control efforts.

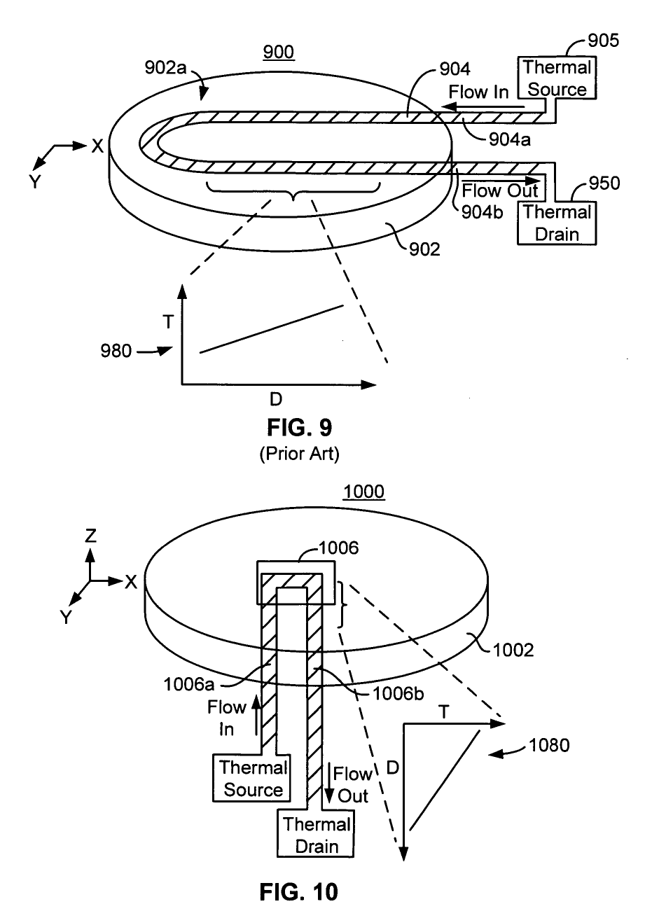

FIG. 9 shows a simplified schematic diagram of a conventional substrate support featuring temperature control capability. Specifically, conventional substrate support 900 includes a body 902 having a channel 904 defined therein for receiving a thermal control fluid 906. This thermal control fluid may comprise a liquid such as water, or a gas such as air or helium, having the capacity to transmit heat to or from a substrate (not shown) supported on an upper surface 902a of body 902.

The thermal control fluid enters the channel at inlet 904a that is in fluid communication with a thermal source (reservoir) 905. Thermal control fluid present in reservoir 905 is maintained at a determined temperature according to the dictates of the user. For example, if the substrate is to be heated, the thermal control fluid in the reservoir is at a temperature greater than the supported wafer. By contrast, if the substrate is to be cooled, the thermal control fluid in the reservoir is at a temperature less than the supported wafer.

Once introduced through inlet 904a, the thermal control fluid flows through channel 904 proximate to the supported wafer. The thermal control fluid flowed through the channel communicates thermal energy through the body to/from the substrate. The channel may exhibit a coiled, serpentine, or labyrinthine shape in order to ensure adequate exposure of the fluid to the various portions of the supported substrate.

The thermal control fluid exits the channel at outlet 904b in fluid communication with a thermal drain 950. Used thermal control fluid may be discarded. Alternatively, the temperature of the used thermal control fluid may be adjusted, and the fluid re-introduced to the reservoir to again regulate a temperature of the processed substrate.

In the conventional structure shown in FIG. 9, the channel is oriented such that the flow of thermal control fluid lies in the plane occupied by the wafer. This direction of flow results in a thermal gradient 980 lying within the plane of the wafer being processed. That is, because the thermal control fluid will accumulate thermal energy over its flow path, the temperature of the thermal control fluid at the channel inlet 904a, will be substantially different from the temperature of the thermal control fluid at the channel outlet 904b.

As a result of this accumulation of thermal energy, the fluid within the channel will exhibit a gradient. For example, where the thermal control fluid is absorbing heat from the substrate, the temperature of the fluid at the outlet will likely be substantially higher than its inlet (reservoir) temperature. Where this gradient lies in the plane of the substrate, different substrate regions will experience different temperature control. This uneven thermal control is highly undesirable, as it can introduce variation in processing different portions of the wafer.

Accordingly, FIG. 10 shows a simplified schematic view of one embodiment of a substrate support of the present invention. Like the conventional support, substrate support 1000 includes a body 1002 having channel(s) defined therein for receiving a thermal control fluid from a thermal source (reservoir), exposing the fluid to thermal energy from a substrate, and then flowing the thermal control fluid to a thermal drain.

Unlike the conventional support structure, however, channel 1004 of support 1000 is configured to flow thermal control fluid in a direction substantially normal to the plane defined by the supported wafer. Specifically, pixel 1006 includes inlet 1006a receiving a flow of thermal control fluid from a thermal source (reservoir), and an outlet 1006b removing the flowed thermal control fluid to a thermal drain.

Because the thermal control fluid is introduced and removed from the pixel in a direction substantially normal to the plane of the wafer, temperature gradient 1080 resulting from this exposure also lies perpendicular to the wafer. Such an orientation of the temperature gradient desirably avoids introducing variation into the thermal treatment of different regions of the wafer.

For example, water is typically utilized as a thermal control fluid. The temperature gradient of water exposed to thermal energy from a substrate, depends upon the rate of flow of water through the channel. However, such water flow rates may be subject to fluctuation during processing.

In the conventional structure shown in FIG. 9, such water flow rate fluctuation would alter the temperature gradient in the plane of the processed substrate, resulting in portions of the substrate experiencing a change in temperature.

By contrast, in the embodiment of the present invention shown in FIG. 10, a fluctuation in water flow rate would have minimal consequences, as the temperature gradient would change in a direction perpendicular to the processed substrate. And, as the substrate is comprises of a plurality of identical pixels in common fluid communication with the source, a change in temperature gradient attributable to fluctuation in water flow, would be experienced by all regions of the wafer in the same manner. This would reduce the likelihood of uneven processing of different portions of the substrate.

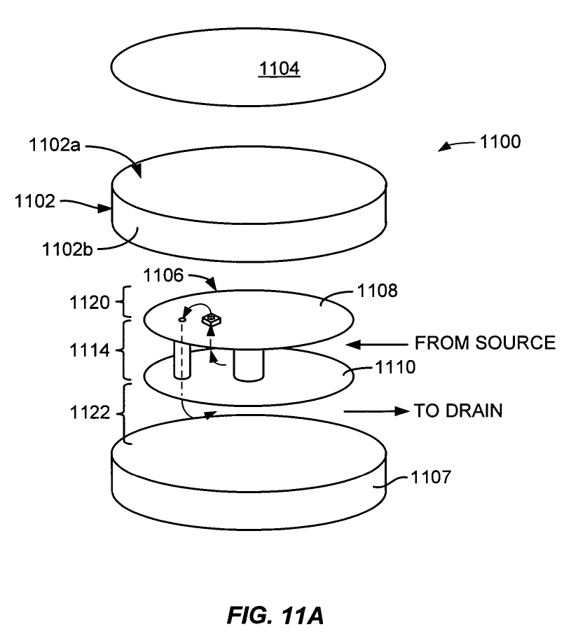

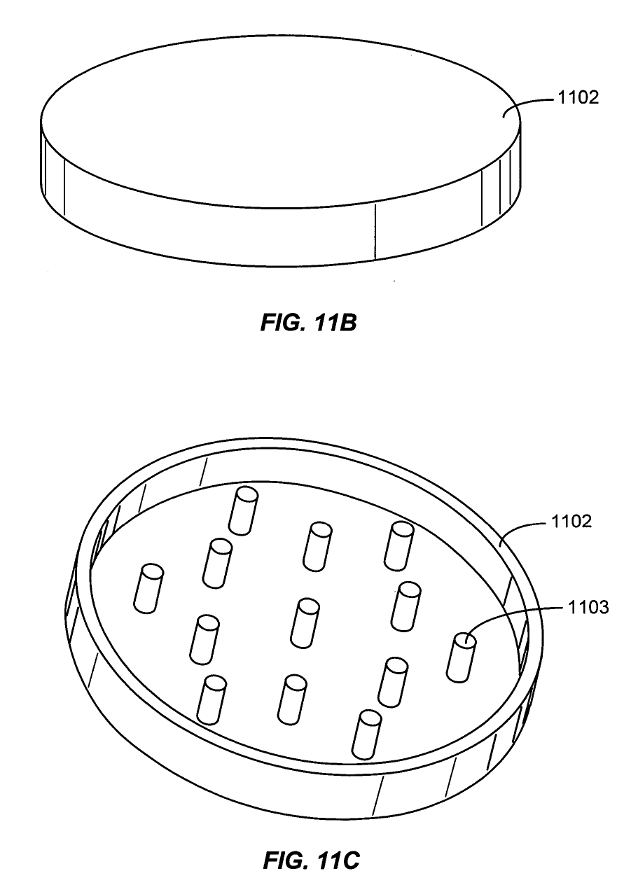

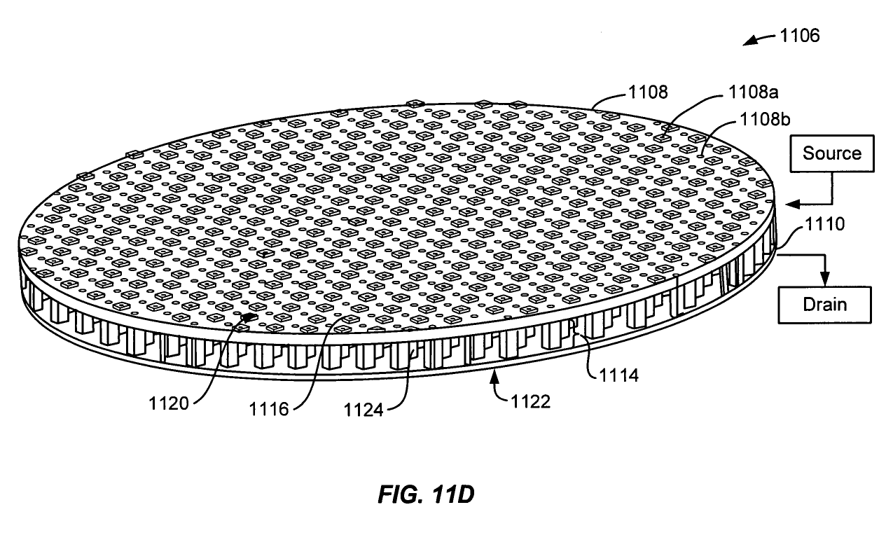

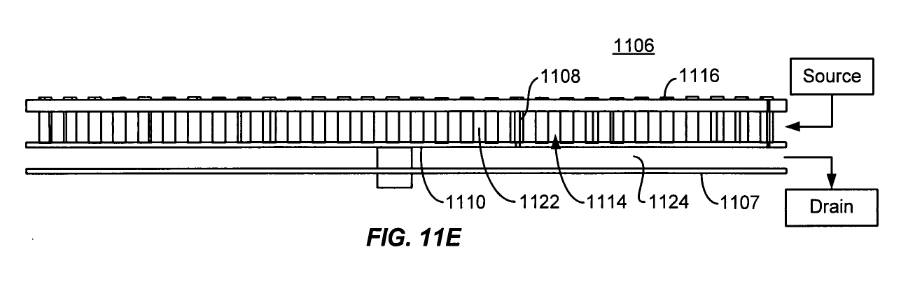

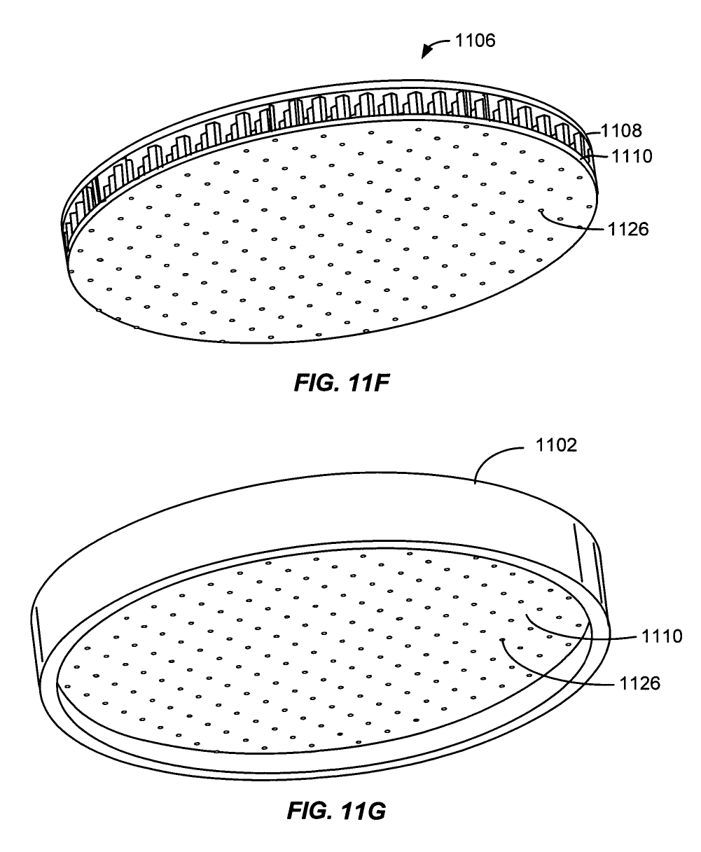

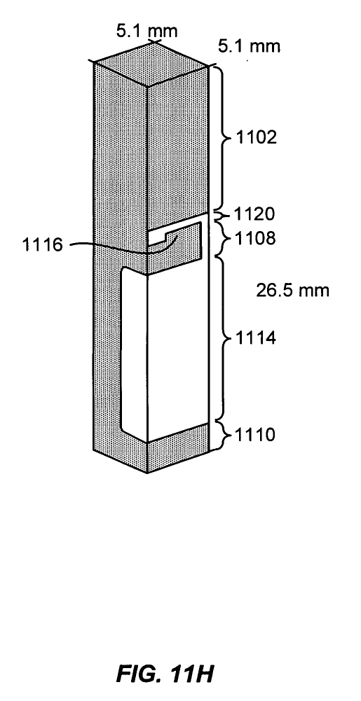

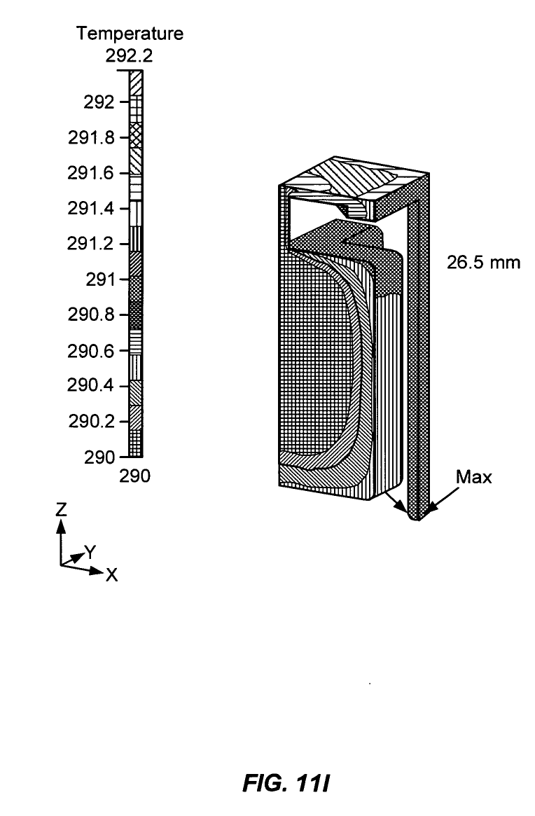

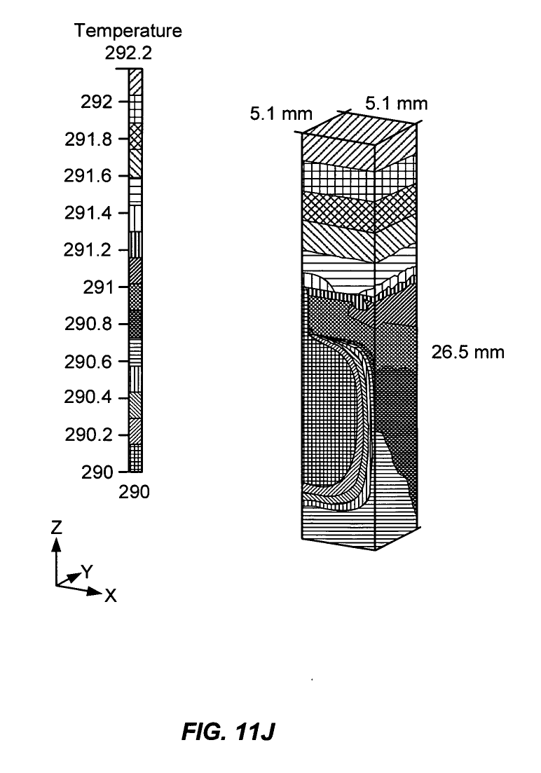

FIG. 11A is an exploded view of one embodiment of a substrate support in accordance with the present invention. Support 1100 comprises top cover or can 1102 having lower walls 1102b and surface 1102a upon which substrate 1104 can rest. FIG. 11B shows an upper perspective view of top cover 1102. FIG. 11C shows an inverted perspective view showing top cover 1102 having a plurality of internal reinforcements 1103 to prevent the wafer surface from bowing.

FIG. 11A also shows thermal plenum 1106 housing a plurality of pixel-like thermal cells, which are sandwiched between top cover 1102 and a bottom cover 1107. FIG. 11C shows an upper perspective view of the thermal plenum 1106. FIG. 11D shows a simplified cross-sectional view of the thermal plenum 1106.

Thermal plenum 1106 comprises a first plate 1108 and a second plate 1110. Thermal control fluid is flowed from a hot or cool source 1112 (reservoir) into region 1114 lying between the first and second plates. The upper surface of first plate features a plurality of raised square boss structures 1116 defining openings 1108a of a first type which allow the inlet fluid flow from region 1114 through plate 1108 into pixel region 1120. In pixel region 1120, the thermal control fluid is in thermal communication with a substrate through the overlying top cover, which is omitted from FIG. 11D.

First plate 1108 also defines a plurality of openings 1108b of a second type that are in fluid communication with a region 1122 defined between the second plate and bottom cover 1107. Thermal control fluid outlet from the pixel region flows through rectangular boss structures 1124 through region 1114 and enters region 1122 defined between the second plate and the bottom cover. The thermal control fluid flows therefrom out of the support to a thermal drain.

FIG. 11F illustrates a lower perspective view of the thermal plenum without a bottom cover in place. FIG. 11G illustrates a lower perspective view of thermal plenum positioned within the top cover, but without a bottom cover. These views show the outlet holes 1126 defined in second plate 1110 of the second type arranged in an array configuration. Thermal fluid would return from the pixel through these holes.

FIG. 11H shows a perspective view of a quarter cross section view of one embodiment of a pixel of a thermal fluid cell. As merely as an example, this embodiment has the dimensions shown. Other dimensions may be suitable for different embodiments.

FIG. 11I illustrates a distribution of temperature within a volume of water thermal control fluid in the support apparatus shown in FIG. 11H. A quarter cross-sectional view is shown. FIG. 11I indicates that the water temperature is maintained at 291+/−2° K.

FIG. 11J illustrates a distribution of temperature within a volume of water thermal control fluid and the overlying aluminum of the top cover, of the support apparatus shown in FIG. 11H. A quarter cross-sectional view is shown. FIG. 11J illustrates temperature distribution inside a water pixel cell and the warm aluminum.

The preceding discussion relates only to one particular embodiment of thermal regulation of a workpiece in accordance with the present invention. Variations of this embodiment would remain within the scope of the present invention.

For example, the embodiment of FIGS. 11A-J features a thermal plenum having an upper plate in which the fluid inlet holes are raised relative to the fluid outlet holes, in order to provide some a vertical flow component normal to the plane of the workpiece. However, this is not required by the present invention, and alternative embodiments could feature a thermal plenum having an upper plate in which the outlet holes are raised relative to the inlet holes.

Moreover, the embodiment described above features a plurality of pixel-like regions corresponding to the location of inlet and outlet holes in the upper plate. Such regions are pixel-like, in that the space between the can and the upper plate of the plenum is undivided and could allow for some circulation of thermal control fluid.

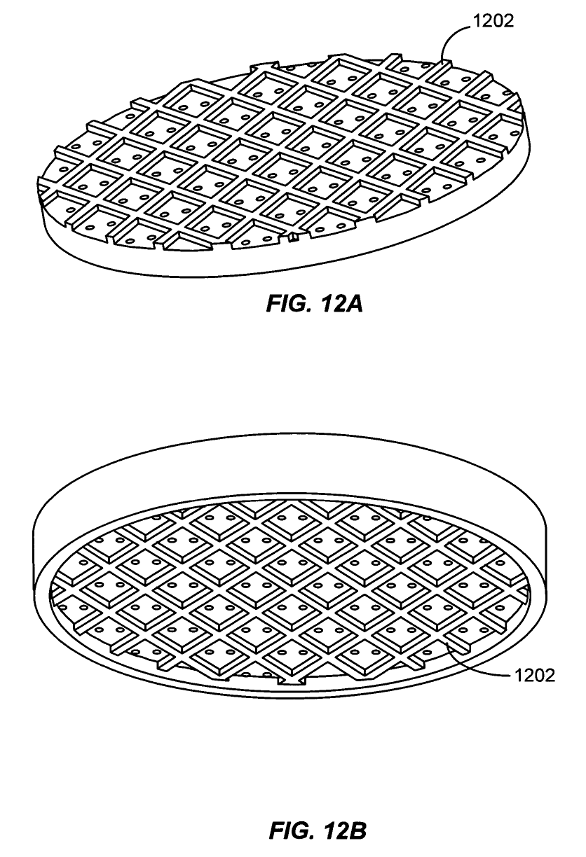

As shown in the perspective views of FIGS. 12A-B, however, alternative embodiments in accordance with the present invention could feature a region formally partitioned into individual pixels with raised partitions 1202 located on the upper plate (FIG. 12A), or located on the lower surface of the can (FIG. 12B). The presence of such partitions would preclude mixing of thermal control fluid between different inlet/outlet hole pairs.

Merely by way of example in the above figures, a substrate support exhibiting a substantially circular shape is shown. Such a circular shape is particularly suitable for processing a single crystal silicon semiconductor wafer, which is typically round. Embodiments in accordance with the present invention, however, are not limited to controlling temperature of only this type of a processed substrate. Thus in accordance with alternative embodiments of the present invention, a substrate support and temperature control apparatus may exhibit other shapes. For example, a flat panel display comprising glass may be rectangular in shape, and the corresponding supporting structure may also assume such a shape.

Moreover, in accordance with certain specific embodiments, the thermal plenum may be formed from aluminum. However, one of ordinary skill in the art would recognize many variations, modifications, and alternatives. For example, the plenum could alternatively be formed from a ceramic material.

Furthermore, while the embodiment described in detail above utilizes flowed water as a thermal control fluid, the present invention is not limited to this particular example. Alternative embodiments in accordance with the present invention could utilize other types of thermal control fluids, including but not limited to gases such as air, helium, nitrogen, or mixtures thereof.

Many benefits may be achieved utilizing embodiments in accordance with the present invention. One such advantage is improved uniformity of temperature control.

As described above, embodiments of the present invention introduce and remove a thermal control fluid to the processed substrate in a direction normal to the plane of the substrate. This manner of flow results in an orientation of the temperature gradient that is also normal to the plane of the wafer, thereby limiting the effect of the temperature gradient on processing of different areas of the workpiece.

Moreover, the fluid is flowed in this manner to the substrate utilizing a plurality of identical pixels arranged in an array. As each pixel is in fluid communication with the same reservoir, this configuration ensures that every portion of the wafer experiences extremely similar temperature control conditions, thereby enhancing uniformity of processing.

In addition, arrangement of the thermal control regions in the pixel-like configuration shown, promotes scalability. This allows a support structure having the desired characteristics to be readily constructed to uniformly regulate temperature of substrates of different shapes and sizes.

It is also understood that the examples and embodiments described herein are for illustrative purposes only, and that various modifications or changes in light thereof will be suggested to persons skilled in the art and are to be included within the spirit and purview of this application and scope of the appended claims.

What is claimed is:

1. An apparatus for processing a semiconductor workpiece comprising:
an upper surface configured to support a workpiece; and
a plenum in thermal communication with the upper surface and comprising a first region in thermal communication with a source of a thermal control fluid and a drain of the thermal control fluid, such that a resulting thermal gradient in the thermal control fluid is oriented substantially normal to a plane defined by the upper surface.

2. The apparatus of claim 1 wherein the thermal plenum comprises:
a lower plate;
an upper plate separated from a lower plate to define a second region, the upper plate defining a first hole allowing flow of the thermal control fluid between the first and second regions, the second region configured to be in fluid communication with one of the source and the drain; and
a boss located in the second region and in fluid communication with a second hole defined by the upper plate, and with a third hole defined by the lower plate.

3. The apparatus of claim 2 further comprising a bottom cover defining with the lower plate, a third region in fluid communication with the third hole and with the other of the source and the drain.

4. The apparatus of claim 3 wherein the upper surface is formed by a can having lower side walls, the can defining with the upper plate, the first region.

5. The apparatus of claim 4 further comprising a partition configured to separate the first region into a plurality of pixels.

6. The apparatus of claim 2 wherein the first hole is defined in a raised portion of the upper plate.

7. The apparatus of claim 1 wherein the upper surface and the thermal plenum are substantially circular in shape in order to support a semiconductor wafer workpiece.

8. The apparatus of claim 1 wherein the upper surface and the thermal plenum are one of substantially rectangular and square in shape in order to support a flat panel workpiece.

9. The apparatus of claim 1 wherein the thermal control fluid is selected from the group comprising water, air, helium, and nitrogen.

10. A method of controlling temperature of a workpiece, the method comprising:
exchanging thermal energy between a workpiece and a thermal control fluid flowed in a direction substantially normal to a plane of the workpiece, such that a thermal gradient arising in the thermal control fluid also lies in the direction substantially normal to the workpiece.

11. The method of claim 10 wherein the thermal control fluid is flowed substantially normal to the workpiece in a region separated from the workpiece by an upper surface of a can structure.

12. The method of claim 11 wherein the thermal control fluid is flowed substantially normal to the workpiece in a plurality of locations.

13. The method of claim 12 wherein the region is partitioned.

14. The method of claim 11 wherein:
the region is defined between the can and a plate;
the thermal control fluid is flowed to the region through a first plate hole in fluid communication with one of a thermal source and a thermal drain; and
the thermal control fluid is flowed from the region through a second plate hole in fluid communication with the other of the thermal source and the thermal drain.

15. The method of claim 14 wherein one of the first plate hole and the second plate hole is raised relative to the other of the first plate hole and the second plate hole.

16. The method of claim 14 wherein:
the thermal control fluid is flowed to the first plate hole through a second region defined between the plate and a second plate; and
the thermal control fluid is flowed from the second plate hole through the second region utilizing a boss structure.

17. The method of claim 10 wherein the flowed thermal control fluid is selected from the group consisting of water, air, helium, and nitrogen.

18. The method of claim 10 wherein the workpiece is subjected to processing with a resist material.

19. A method of controlling a temperature of a workpiece comprising:
forming a resist material on a workpiece; and
exchanging thermal energy between a workpiece and a thermal control fluid flowed in a direction substantially normal to a plane of the workpiece, such that a thermal gradient arising in the thermal control fluid also lies in the direction substantially normal to the workpiece.

20. The method of claim 19 wherein one of photoresist and electron beam resist are formed on the workpiece.
